(19) United States
(12) Patent Application Publication
(10) Pub. No.: US 2002/0054049 A1
(43) Pub. Date: May 9, 2002

(54) IMAGE PLAYBACK APPARATUS, IMAGE RECORDING APPARATUS, AND METHODS THEREOF

(76) Inventors: KENJI TOYODA, CHIGASAKI-SHI (JP); HIDEO HIBINO, YAMATO-CITY (JP)

Correspondence Address: MITCHELL W. SHAPIRO, MILES & STOCKBRIDGE P.C., 1751 PINNACLE DRIVE, SUITE 500, MCLEAN, VA, 22102-3833, US

(21) Appl. No.: 08/968,513

(22) Filed: Nov. 12, 1997

Related U.S. Application Data
(60) Provisional application No. 60/052,766, filed on Jul. 17, 1997.

(30) Foreign Application Priority Data
Nov. 12, 1996 (JP) 8-300250

(51) Int. Cl. G06F 13/00; H04N 5/91

(52) U.S. Cl. 345/700

(57) ABSTRACT

An image playback apparatus and in image recording apparatus are designed to permit image playback from a selected position in an image file recorded to a directly accessible memory, such as a magnetic disk. During recording of an image file, the user can designate one or more candidate playback start positions in the file, and corresponding pointers are stored as part of the image file. When the file is to be played back, the playback apparatus accesses the pointer(s) and allows the user to select playback from the corresponding position(s) in the image file. Also the playback apparatus can rewrite pointers in an image file, whereby the user can designate candidate starting positions for future playback of the file.

### CROSS-REFERENCE TO RELATED APPLICATIONS

This application claims the benefit of provisional application No. 60/052,766 filed Jul. 17, 1997.

This application also claims the priority of Japanese Patent Application No. 8-300250 filed Nov. 12, 1996, which is incorporated herein by reference.

### BACKGROUND OF THE INVENTION

1. Field of the Invention

The present invention relates to an image playback apparatus and method for reading out an image file from a directly accessible storage medium, and to an image recording apparatus and method for writing an image file in a directly accessible storage medium.

2. Related Background Art

In video tape recorders adapted to read out image information written in magnetic tapes, the image information is sequentially accessed and played back. To play back the image information from a position desired by an operator, it is therefore necessary to skip the image information present before that position.

In recent years, image playback apparatus and image recording apparatus have come into practice which use a directly accessible memory, such as a magnetic disk, as a recording medium, instead of the sequential access memory such as the above-described magnetic tape. In such an image playback apparatus, playback is carried out by directly accessing an image file selected by the operator from among a plurality of image files consisting of image information of moving pictures, for example.

Image editing software is also known for reading out an image file and performing image processing for editing. With such software, it is possible to play back an image file from a position designated by the operator.

In the above-described image playback apparatus, the image file starts being read out from its leading position every time. This gives rise to a significant drawback in that it is impossible to start reading out an image file that has been played back only part-way from the position at which playback was interrupted.

In the above-described software for image editing, the position designated during the previous read-out operation is not recorded. This gives rise to a significant drawback in that the operator must designate a playback position each time a given image file is to be read out again.

### SUMMARY OF THE INVENTION

The present invention was conceived in view of the aforementioned drawbacks and has, as one of its objects, to provide an image playback apparatus capable of starting playback from a desired position in an image file.

Another object of the invention is to provide an image playback apparatus that can re-start playing back an image file from a position at which playback of the image file was interrupted.

Still another object of the invention is to provide an image playback apparatus capable selecting the playback position.

A further object of the invention is to provide an image recording apparatus capable of designating, during writing of an image file, a position in the file at which playback is to be started.

A still further object of the invention is to provide an image recording apparatus that enables an image playback apparatus to select the playback position.

A still further object of the invention is to provide image playback and recording methods that overcome the aforementioned drawbacks of the previous techniques.

Briefly stated, the apparatus and methods of the present invention are designed to allow an operator to select image playback based on stored positional information indicating one or more playback-starting positions of the image file. According to one aspect of the invention, the playback-starting position(s) may be designated by the user during recording of the image file. According to another aspect of the invention, the playback-starting position(s) may be designated by the user during playback of the image file, such as by stopping the playback operation to set a bookmark corresponding to the stopped position or by setting one or more discretionary bookmarks during the playback. Preferably, thumbnail images are produced in association with the playback-starting position(s) to provide a basis for advance confirmation of the image content at the playback-starting position(s).

The principles of the invention, as well as its various aspects, features, and advantages, will be more fully appreciated from the following detailed description taken in conjunction with the accompanying drawings.

### BRIEF DESCRIPTION OF THE DRAWINGS

FIG. 1 is a basic block diagram of an image playback apparatus according to the present invention.

FIG. 2 is a block diagram showing a first modification of the apparatus in FIG. 1.

FIG. 3 is a block diagram showing a second modification of the apparatus in FIG. 1.

FIG. 4 is a block diagram showing a third modification of the apparatus in FIG. 1.

FIG. 5 is a block diagram showing a fourth modification of the apparatus in FIG. 1.

FIG. 6 is a basic block diagram of an image recording apparatus according to the present invention.

FIG. 7 is a block diagram showing a modification of the apparatus in FIG. 6.

FIG. 8 is a block diagram of a preferred embodiment implementing the principles of the invention as shown in FIGS. 1, 2 and 4.

FIG. 9 is a flow chart of the operation of the embodiment in FIG. 8.

FIGS. 10A to 10C are views showing examples of a display on a monitor.

FIG. 11 is a view showing another example of a display on the monitor.

FIG. 12 is a diagram of the arrangement of an image file.

FIG. 13 is a block diagram of a preferred embodiment implementing the principles of the invention as shown in FIGS. 1, 2 and 5.

FIG. 14 is a flow chart of the operation of the embodiment in FIG. 13.

FIG. 15 is a diagram of another arrangement of an image file.

FIG. 16 is a block diagram of a preferred embodiment implementing the principles of the invention as shown in FIGS. 1 and 3.

FIG. 17 is a flow chart of the operation of the embodiment in FIG. 16.

FIG. 18 is a block diagram of a preferred embodiment implementing the principles of the invention as shown in FIGS. 6 and 7.

FIG. 19 is a flow chart of the operation of the embodiment in FIG. 18.

### DETAILED DESCRIPTION OF THE INVENTION

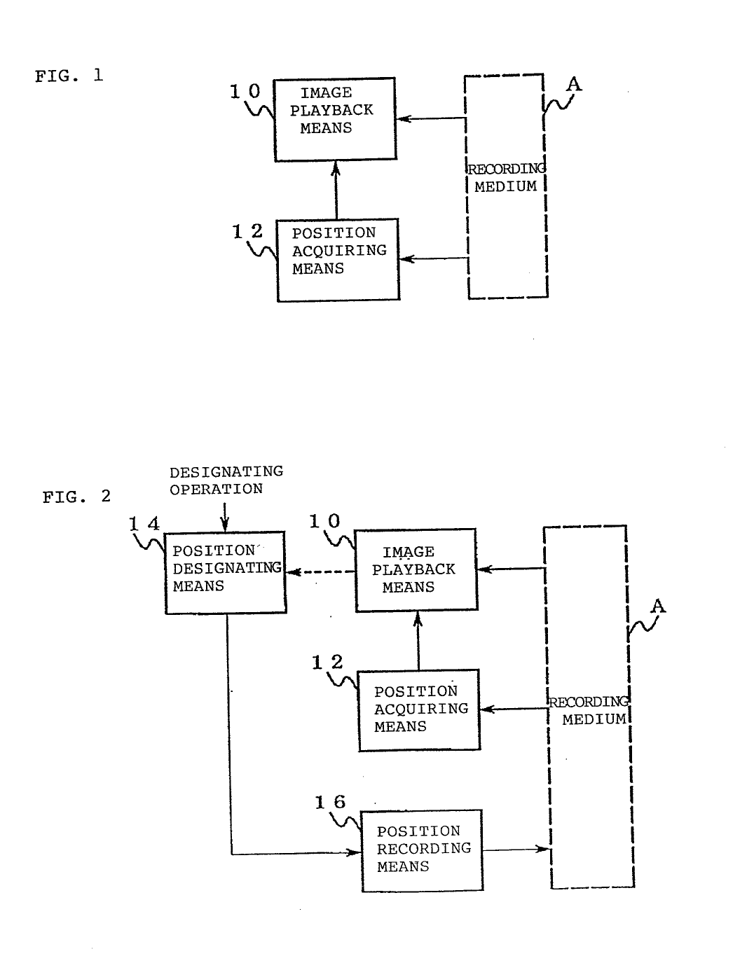

FIG. 1 is a basic block diagram of an image playback apparatus according to the present invention.

This image playback apparatus comprises image playback means 10 for directly accessing an image file on a recording medium A, and for reading out and playing back the image file. The apparatus also includes position acquiring means 12 for acquiring positional information from a storage location determined based on a file format of the image file. The positional information indicates a playback position of the image file an is preferably stored as part of the image file on the recording medium A. The image playback means 10 starts playing back the image file from the playback position indicated by the positional information when the positional information is acquired by the position acquiring means 12.

In operation of the image playback apparatus of FIG. 1, the position acquiring means 12 acquires the positional information indicating the playback position of the image file. The image playback means 10 directly accesses the playback position indicated by the acquired positional information and starts playback of the image file from that playback position. Thus, playback can started from the stored position even when the same image file is played back again.

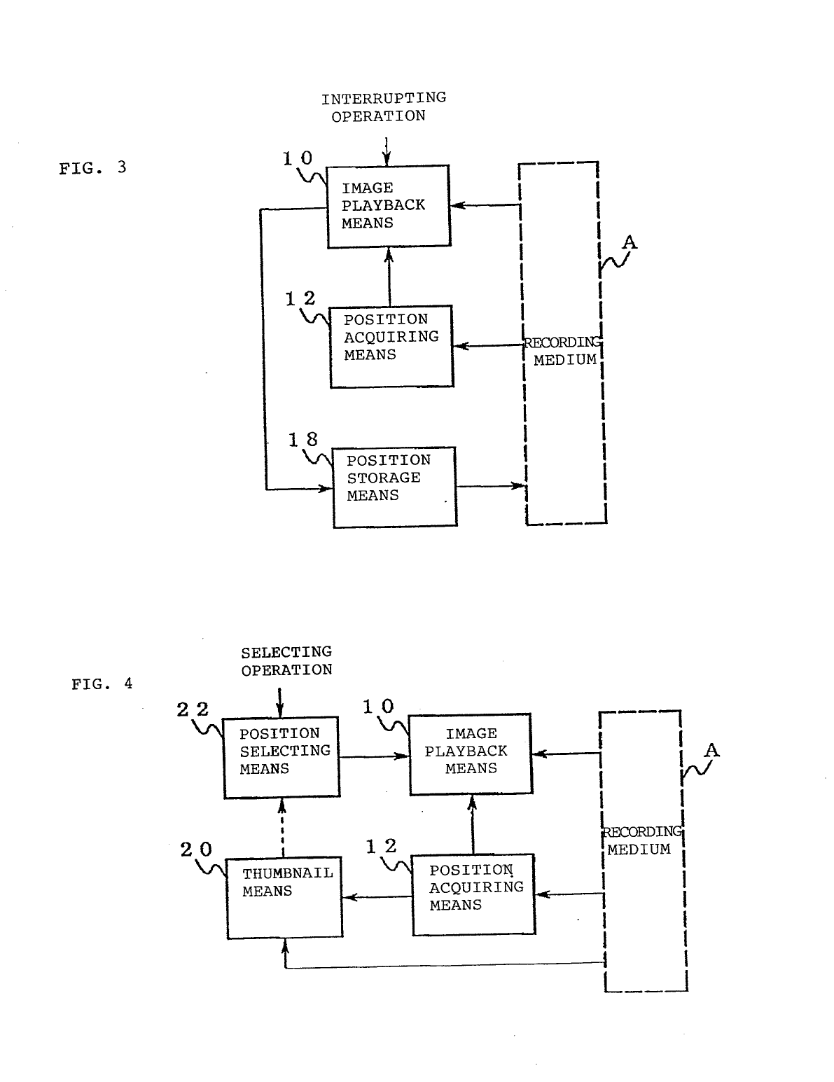

FIG. 2 is a block diagram showing a first modification of the basic image playback apparatus shown in FIG. 1.

As shown in FIG. 2, the image playback apparatus additionally comprises position designating means 14 for designating the playback position of the image file based on a designating operation given from outside during playback of the image file by the image playback means 10, and position recording means 16 for storing, as the positional information in the storage location, the playback position designated by the position designating means 14.

In operation of the image playback apparatus of FIG. 2, the position designating means 14 receives a designating instruction from outside while the image file is being played back by the image playback means 10. The position designating means 14 then specifies the position at which the image file is being played back at the point in time when the designating instruction is received.

The position recording means 16 stores positional information, indicating the position specified by the position designating means 14, at the storage location determined based on the file format of the image file. Therefore, when the same image file is played back again, the playback starting position in the later playback operation is the position designated by the operator during the previous playback operation. The starting position can be any position designated by the operator.

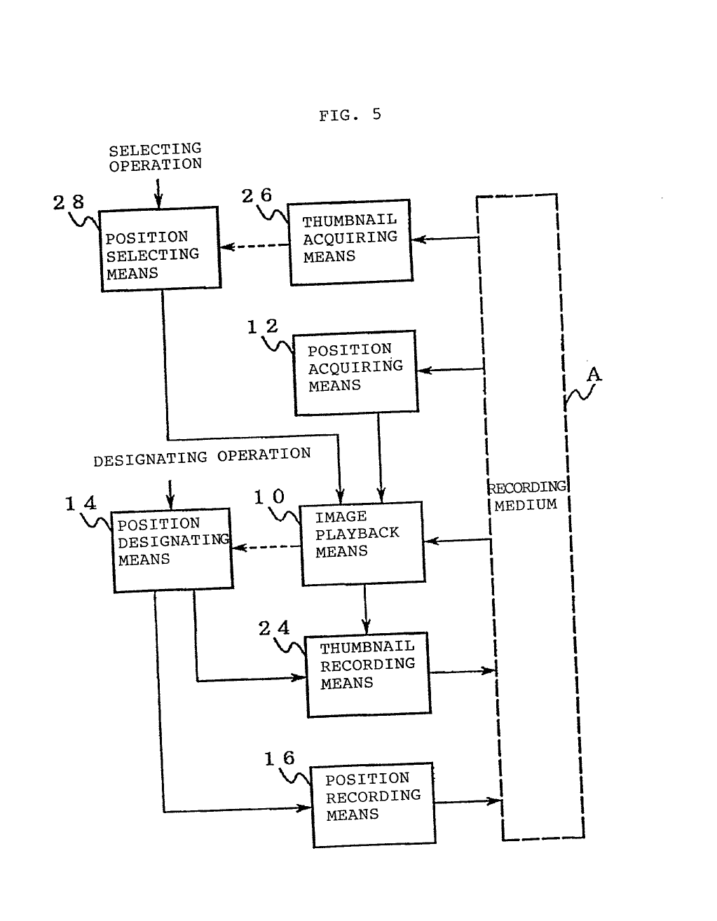

FIG. 3 is a block diagram showing a second modification of the apparatus in FIG. 1.

In the form shown in FIG. 3, the image playback apparatus additionally includes position storage means 18, and the image playback means 10 interrupts playback of the image file in response to an interrupting instruction given from the outside. The position storage means 18 stores the position of the image file at which playback is interrupted by the image playback means as the positional information in the storage location determined based on the file format of the image file.

In operation of the image playback apparatus of FIG. 3, the image playback means 10 interrupts playback of an image file at a point in time when an interrupt instruction is given from outside. The position storage means 18 stores, in the storage location determined based on the file format of the image file, positional information indicating the position in the image file at which the playback was interrupted by the image playback means 10. Therefore, when the image file for which playback was interrupted is played back again, the playback is started from the interrupted position, so that the part of the image file before the interrupted position is not played back again.

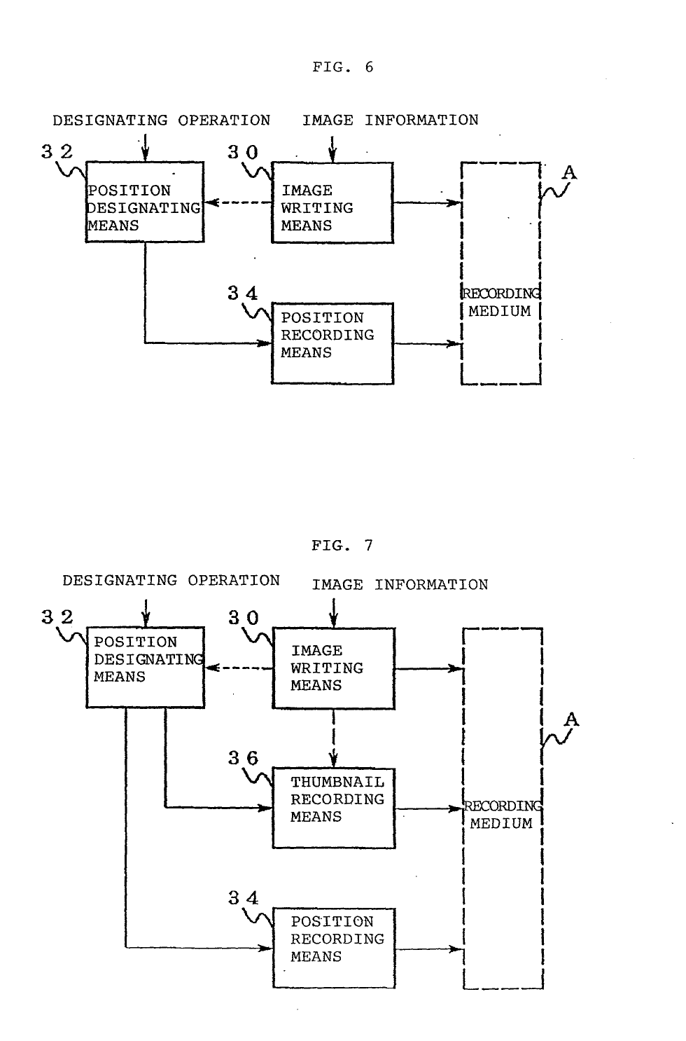

FIG. 4 is a block diagram showing a third modification of the apparatus in FIG. 1.

As shown in FIG. 4, the image playback apparatus additionally comprises thumbnail means 20 for producing and displaying a thumbnail image from an image at the playback position indicated by the positional information when the positional information is acquired by the position acquiring means 12. If positional information for a plurality of playback positions is stored, which may be preferred to provide greater flexibility, the thumbnail means 20 produces and displays a plurality of thumbnail images corresponding to the respective playback positions.

The apparatus also includes position selecting means 22 for specifying the playback position in accordance with the an external selecting instruction by which the single thumbnail image, or, in the case of plural thumbnail images, one of the thumbnail images, is selected. The image playback means 10 starts playback of the image file from the playback position specified by the position selecting means 22.

In the image playback apparatus of FIG. 4, when the positional information is acquired by the position acquiring means 12, the thumbnail means 20 reads out the image information located at the position(s) indicated by the positional information, and produces the corresponding thumbnail image(s). The thumbnail means 20 also displays the thumbnail image(s) on a screen provided inside or outside of the image playback apparatus.

When the thumbnail image(s) is/are displayed by the thumbnail means 20, the position selecting means 22 receives an external selecting instruction for selecting the/a thumbnail image. Also, the position selecting means 22 specifies the playback position corresponding to the thumbnail image selected by the external selecting instruction.

The image playback means 10 starts playback of the image file at the playback position specified by the position selecting means 22 from the playback position(s) provided by the position acquiring means 12.

The use of one or more thumbnail images as just described is generally advantageous, because the operator can confirm the image located at the playback position in advance by looking at the corresponding thumbnail image.

The operator can therefore quickly and precisely designate the playback position.

FIG. 5 is a block diagram showing a fourth modification of the apparatus in FIG. 1.

As shown in FIG. 5, the image playback apparatus is characterized by the addition of position designating means 14 and position recording means 16 as described in connection with FIG. 2; thumbnail recording means 24 for producing a thumbnail image from an image at the playback position designated by the position designating means 14, and for storing the thumbnail image in the image file such that the thumbnail image is associated with the playback position; thumbnail acquiring means 26 for acquiring the thumbnail image from the image file and displaying the thumbnail image; and position selecting means 28 for specifying the playback position corresponding to the thumbnail image selected by an external selecting operation. The image playback means 10 starts playback of the image file from the playback position specified by the position selecting means 28.

Similarly to the apparatus in FIG. 4, it may be preferred that the positional information be stored for a plurality of starting positions of an image file. In this case, the thumbnail acquiring means acquires and displays a plurality of thumbnail images.

In operation of the image playback apparatus of FIG. 5, the thumbnail acquiring means 26 displays the thumbnail image(s) from the image file at the point in time when the positional information is acquired by the position acquiring means 12. When the thumbnail image(s) is/are displayed by the thumbnail acquiring means 26, the position selecting means 28 is allowed to receive an external selecting instruction to select the/a thumbnail image. The position selecting means 28 also specifies the playback position corresponding to the thumbnail image selected by the external selecting instruction. The image playback means 10 starts playback of the image file from the playback position specified by the position selecting means 28.

When a playback position is designated by the position designating means 14 while playback is being carried out by the image playback means 10, the thumbnail recording means 24 produces a thumbnail image from the playback image at that playback position. The thumbnail recording means 24 also stores the produced thumbnail image in the image file such that the thumbnail image is associated with the designated playback position. The designated position and the thumbnail image may be written over positional information and a thumbnail image associated therewith that were stored previously.

Since a thumbnail image is produced at the point in time when a playback position is designated by the position designating means 14 in the above operation, there is no need to produce the thumbnail image each time the image file is to be played back. That is, there is no need to produce a thumbnail image unless a playback position is changed. As a result, the number of times when the thumbnail image is produced is decreased, and the time required for displaying the thumbnail image(s) is reduced.

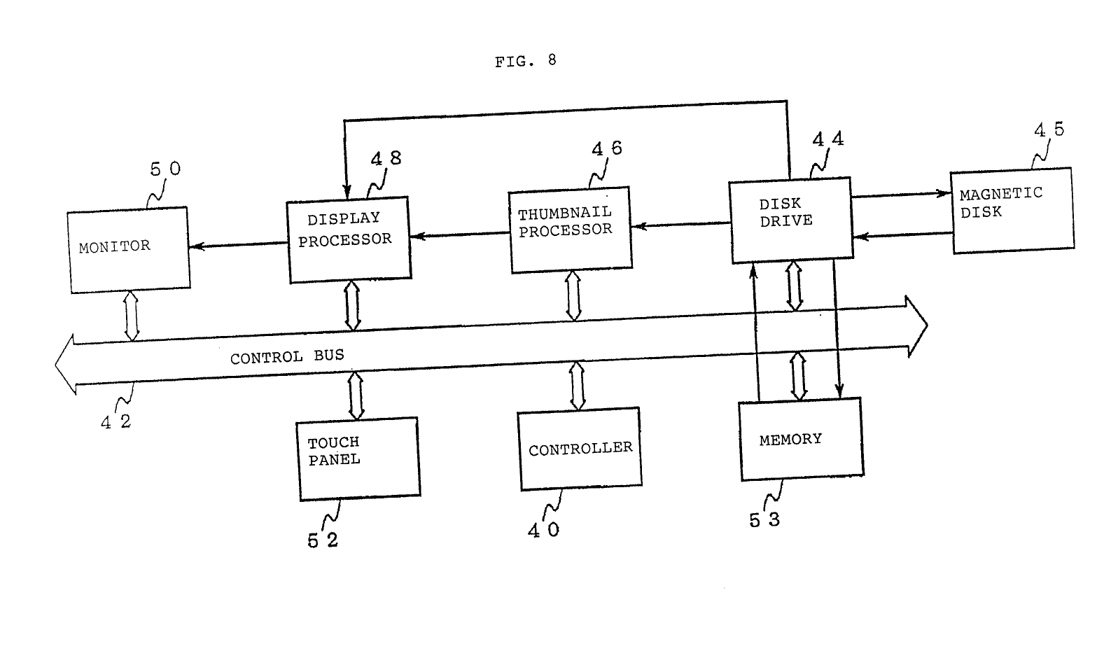

FIG. 6 is a basic block diagram of an image recording apparatus according to the present invention.

This image recording apparatus comprises image writing means 30 for writing image information provided from outside into an image file in a directly accessible recording medium A, position designating means 32 for designating a position in the image file in response to a designating operation given from outside during writing of the image file by the image writing means 30, and position recording means 34 for storing positional information, indicating the position designated by the position designating means 32, at a storage location determined based on a file format of the image file.

In operation of the image recording apparatus of FIG. 6, the image writing means 30 writes the externally provided image information as an image file in the directly accessible recording medium A. The position designating means 32 receives an external designating instruction while the image file is being written by the image writing means 30. In response to this instruction, the position designating means 32 specifies the position at which the image file is being written at the point in time when the designating instruction is received.

The position recording means 34 stores positional information, indicating the position specified by the position designating means 32, at the storage location determined based on the file format of the image file.

Accordingly, the position designated during writing of the image file can be used as the position at which the image playback apparatus starts playback of the image file.

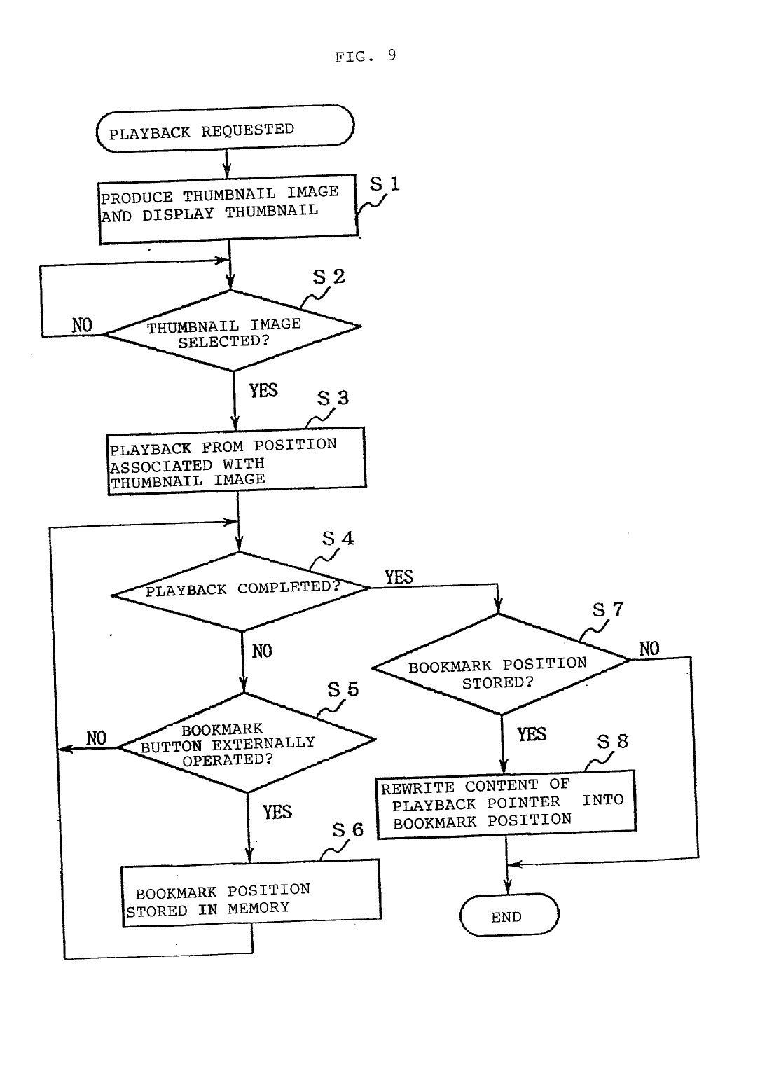

FIG. 7 is a block diagram showing a modification of the image recording apparatus in FIG. 6.

As shown in FIG. 7, the image recording apparatus additionally comprises thumbnail recording means 36 for producing a thumbnail image from an image written in the position designated by the position designated means 32, and for storing the thumbnail image, preferably in the image file, such that the thumbnail image is associated with the designated position.

In the operation of the image recording apparatus of FIG. 7, when a certain position is designated by the position designating means 32 while the image file is being written by the image writing means 30, the thumbnail recording means 36 produces a thumbnail image from the image written at that position. The thumbnail recording means 36 also stores the thus produced thumbnail image in association with the designated position, preferably in the image file.

Accordingly, the thumbnail images produced during writing of the image file may be used for selection of the playback position by the image playback apparatus.

Some specific embodiments of the present invention as implemented in systems using magnetic disk type file storage media will now be described in detail.

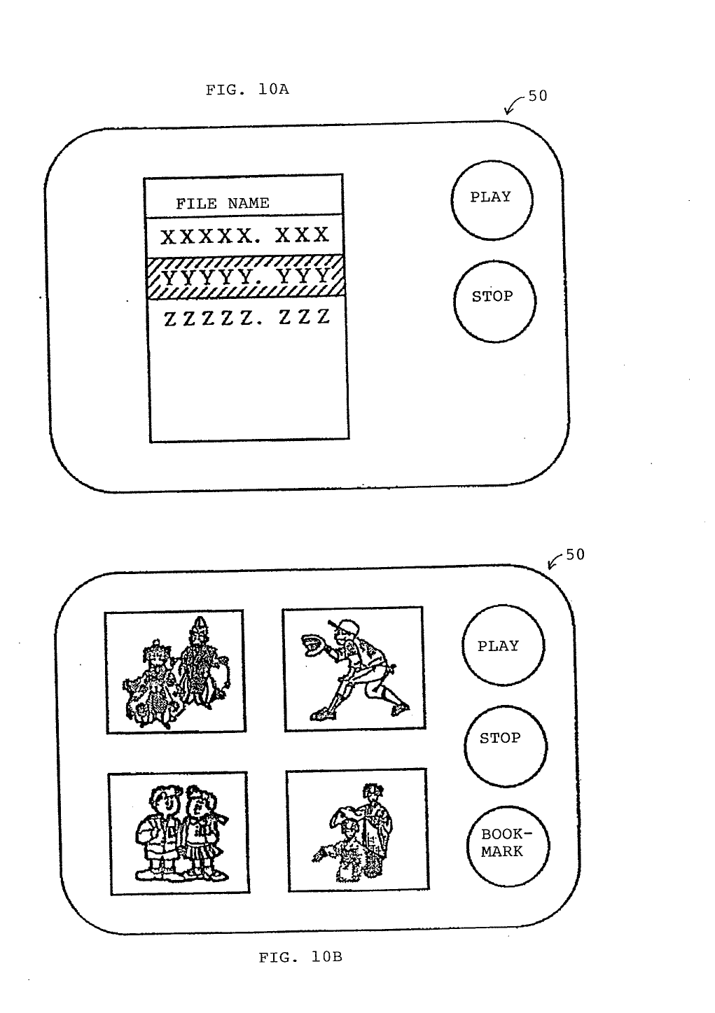

FIG. 8 is a block diagram of an image playback apparatus implementing the principles of the invention as shown in FIGS. 1, 2, and 4.

In the figure, a controller 40 is connected via a control bus 42 to a disk drive 44, a thumbnail processor 46, a display processor 48, a monitor 50, a touch panel 52 (disposed on the screen of monitor 50), and a memory 53. A magnetic disk 45 is loaded in the disk drive 44. A plurality of image files and an index containing file names and starting addresses of the respective image files and other file management information are written in advance in the magnetic disk 45.

Regarding the relationship between the block diagrams shown in FIGS. 1, 2 and 4 and the present embodiment, the image playback means 10 corresponds to the disk drive 44, display processor 48 and monitor 50; the position acquiring means 12 corresponds to the disk drive 44; the position designating means 14 corresponds to the touch panel 52; the position recording means 16 corresponds to the disk drive 44 and memory 53; the thumbnail means 20 corresponds to the thumbnail processor 46, display processor 48 and monitor 50; the position selecting means 22 corresponds to the touch panel 52; and the recording medium A corresponds to the magnetic disk 45.

The operation of the embodiment of FIG. 8 will now be described.

To inform the operator that playback of the image files is possible, the controller 40 instructs the disk drive 44, display processor 48 and monitor 50 to produce and display a menu screen that permits selection of the image files. In response to this instruction, the disk drive 44 reads out the above-mentioned index from the magnetic disk 45, and supplies it to the display processor 48. Upon receipt of the index, the display processor 48 acquires the file names of all of the image files from the index, and produces image information equivalent to a menu screen of a predetermined format, such as the format shown in FIG. 10A. The thus produced image information is transferred to and displayed on the monitor 50.

The controller 40 constantly monitors for an external operation performed on the touch panel 52. When the menu screen is displayed, the controller 40 determines whether an image file has been selected by external operation of the touch panel. The controller also determines whether a playback button PLAY, which is displayed as part of the menu screen, has been operated by external operation of the touch panel.

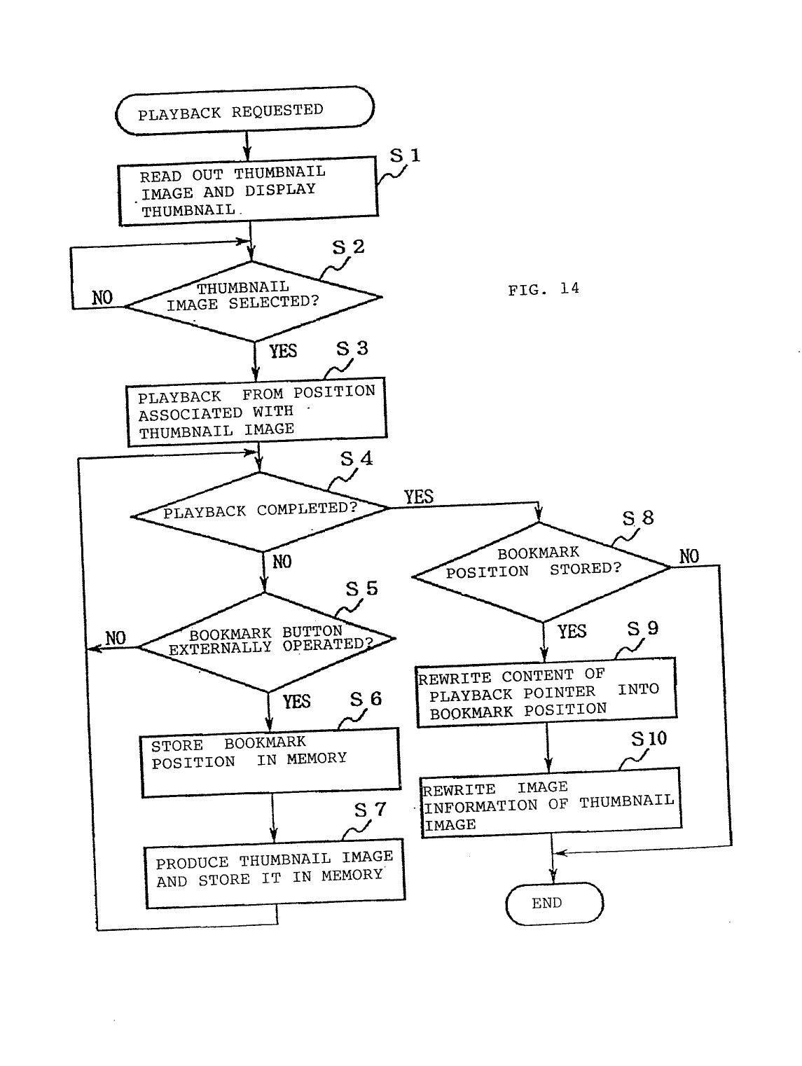

FIG. 12 shows an image file format that can be used in the present embodiment. The image file includes a header region containing accessory information, such as photographing date and time and the total number of frames, and an image region composed of image information. The header region also includes a number n of playback pointers which provide candidate starting positions when the image information is read out. In the illustrative form, it is assumed that the number of playback pointers is 4 (n=4), but a larger or smaller number may be used in practice. A certain value is set in advance in each playback pointer, for indicating a corresponding candidate read-out starting position.

FIG. 9 is a flow chart of the operation from the point in time when playback of a selected image file is requested.

When the controller 40 detects that the playback of an image file is requested, it instructs the disk drive 44 to read out the playback pointers. The disk drive 44 then acquires the starting address of the image file to be played back, referring to the above-described index, and reads out all of the playback pointers based on the starting address.

When the controller 40 recognizes that all of the playback pointers have been read out by the disk drive 44, it instructs the disk drive 44, thumbnail processor 46, display processor 48 and monitor 50 to produce thumbnail images corresponding to the respective playback pointers, and display the thumbnail images (step S1 in FIG. 9). In response to this instruction, the disk drive 44 sequentially reads out image information corresponding to one frame from each of the positions indicated by the plurality of playback pointers, and it supplies the information to the thumbnail processor 46. The thumbnail processor 46, when receiving the image information from the disk drive 44, performs pixel density conversion to sequentially produce image information corresponding to thumbnail images, and then supplies the information to the display processor 48.

Upon receipt of the image information of the thumbnail images from the thumbnail processor 46, the display processor 48 sequentially stores the image information of the respective thumbnail images at predetermined locations in a frame memory (not illustrated) incorporated in the processor 48. After storing the image information of all of the thumbnail images in the frame memory, the display processor 48 performs overlay processing on image information corresponding to a PLAY button, a STOP button and a BOOKMARK button, and the thumbnail image information in the frame memory, and supplies the resulting information to the monitor 50. The monitor 50, when receiving the image information subjected to the overlay processing, provides a thumbnail display as shown in FIG. 10B.

When the thumbnail images are displayed, the controller 40 determines whether any of these thumbnail images is selected via the touch panel 52 (step S2 in FIG. 9).

If the controller 40 determines that one of the thumbnail images has been selected, it supplies the disk drive 44 with the value of the playback pointer corresponding to the selected thumbnail image, and also instructs the disk drive 44, display processor 48 and monitor 50 to read out and play back the image information (step S3 in FIG. 9). In response to this instruction, the disk drive 44 reads out the image information beginning from the position indicated by the given playback pointer.

The disk drive 44 is provided with a counter (hereinafter called “read-out counter”) that stores, by frame, the position at which the image information is being read out, and it controls or manages the position in the image file by sequentially updating the read-out counter. Based on the content of the read-out counter, the disk drive 44 can read out the image information at selected positions.

The image information read out by the disk drive 44 is supplied to the display processor 48, where it is decompressed and stored in the frame memory. In the display processor 48, the image information stored in the frame memory and image information corresponding to the PLAYBACK button, the STOP button and the BOOKMARK button are overlay processed, and the resulting information is supplied to the monitor 50. The received image information is played back on the monitor 50, as shown in FIG. 10C.

The controller 40 monitors for completion of the playback operation (step S4 in FIG. 9). If the playback operation is not completed (if NO is obtained in step S4), the controller 40 determines whether the BOOKMARK button has been externally operated via the touch panel 52 (step S5 in FIG. 9). Each time the controller 40 detects that the BOOKMARK button was externally operated, the value of the above-mentioned read-out counter is stored in the memory 53 as a bookmark position (step S6 in FIG. 9). The bookmark position represents the position in the image file of the image information being read out at the point in time when the BOOKMARK button was externally operated.

When the controller 40 detects that playback of the image file has been completed (if YES is obtained in S4), it determines whether a bookmark position has been stored (step S7 in FIG. 9). When at least one bookmark position has been stored, the controller 40 instructs the disk drive 44 to rewrite the content of the playback pointers to include the bookmark position(s) (step S8 in FIG. 9).

The disk drive 44 selects one or more playback pointers from the plurality of playback pointers based on a predetermined order of priority for rewriting, and sequentially writes the bookmark position(s) into the selected playback pointer(s).

The position(s) of the image information at which reading-out was taking place when the BOOKMARK button was externally operated—that is, the bookmark position(s)—is/are thus written into the playback pointers. Therefore, when the operator again requests playback of the same image file, the thumbnail images corresponding to the bookmark positions are displayed in the thumbnail display (FIG. 10 B). When a thumbnail image corresponding to a bookmark position is selected, playback will proceed from that bookmark position.

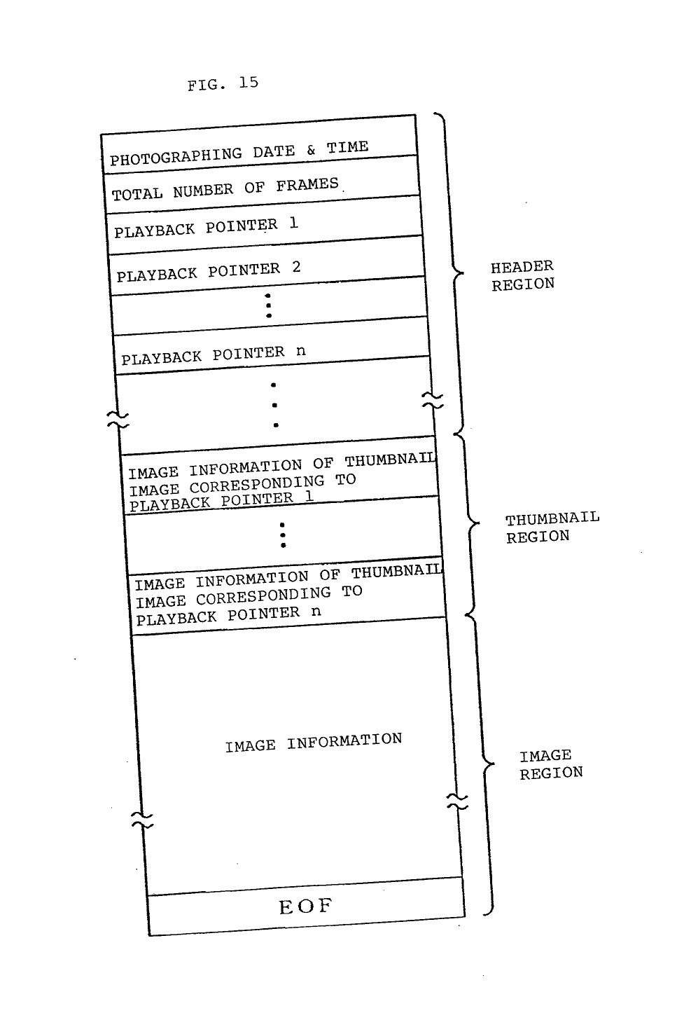

FIG. 13 is a block diagram of an embodiment of the invention implementing the principles shown in FIGS. 1, 2 and 5. In this figure, the same reference numerals are assigned to elements having the same functions as those in the block diagram of FIG. 8, and no further explanation of these elements will be provided.

The arrangement of the present embodiment is different from the arrangement of the embodiment of FIG. 8 in that a controller 54 and a thumbnail producing unit 56 are provided in place of the controller 40 and thumbnail processor 46.

With regard to the relationship between the block diagrams shown in FIGS. 1, 2 and 5 and the present embodiment, the image playback means 10 corresponds to the disk drive 44, display processor 48 and monitor 50; position acquiring means 12 corresponds to the disk drive 44; position designating means 14 corresponds to the touch panel 52; position recording means 16 corresponds to the disk drive 44 and memory 53; thumbnail recording means 24 corresponds to the disk drive 44, thumbnail producing unit 56 and memory 53; thumbnail acquiring means 26 corresponds to the disk drive 44, display processor 48 and monitor 50; position selecting means 28 corresponds to the touch panel 52; and the recording medium A corresponds to the magnetic disk 45.

In the present embodiment, each image file has a thumbnail region in addition to the header region and image region, as shown in FIG. 15. The thumbnail region is composed of image information of thumbnail images corresponding to respective playback pointers. For the sake of simplicity, it is assumed that image information of the thumbnail images corresponding to the respective playback pointers is stored in advance in the thumbnail region.

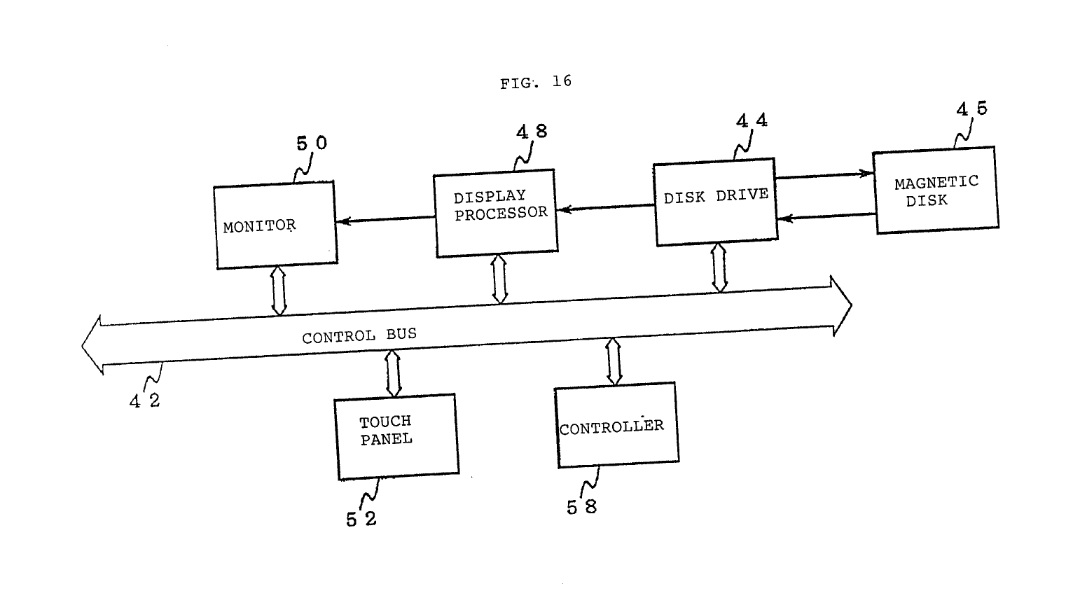

FIG. 14 is a flow chart of the operation of the present embodiment.

As in the embodiment of FIG. 8, when the controller 54 recognizes that playback of an image file has been requested, it instructs the disk drive 44 to read out the corresponding playback pointers.

When the playback pointers are read out, the controller 54 instructs the disk drive 44, display processor 48 and monitor 50 to read out image information of thumbnail images corresponding to the respective playback pointers, and to display the thumbnail images (step S1 in FIG. 14). The disk drive 44 then reads out the image information of the thumbnail images corresponding to the respective playback pointers from the thumbnail region. The image information of the thumbnail images read out in this manner is stored in a frame memory (not shown) of the display processor 48, and processed to overlay image information corresponding to the PLAY button, etc., as in the embodiment of FIG. 8. The thumbnail display, as shown in FIG. 10B, is then displayed on the monitor 50.

When the thumbnail images are displayed, the controller 54 determines whether any one of the thumbnail images has been selected (step S2 in FIG. 14), in the same manner as in the embodiment of FIG. 8.

If selection of a thumbnail image is detected, the controller 54 supplies the value of the playback pointer corresponding to the selected thumbnail image to the disk drive 44, and instructs the disk drive 44, display processor 48 and monitor 50 to read out and play back the image information (step S3 in FIG. 14). In response to this instruction, the disk drive 44 reads out the image information starting from the position indicated by the given playback pointer, while updating the read-out counter, in the same manner as in the embodiment of FIG. 8.

The image information read out by the disk drive 44 is supplied to the display processor 48, and also supplied to the thumbnail producing unit 56. The display processor 48 decompresses the supplied image information, stores it in the frame memory, performs overlay processing on this image information and the image information corresponding to the PLAY button, etc., and supplies the resulting image information to the monitor 50, as in the embodiment of FIG. 8. The received image information is played back on the monitor 50, as shown in FIG. 10C.

The controller 54 monitors for completion of the playback operation (step S4 in FIG. 14). If the playback operation is not completed (if NO is obtained in step S4), the controller 40 determines whether the BOOKMARK button has been externally operated via the touch panel 52 (step S5 in FIG. 14).

Each time the controller 54 recognizes that the BOOKMARK button was externally operated, it stores the value of the read-out counter in the memory 53 as a bookmark position (step S6 in FIG. 14), and instructs the thumbnail producing unit 56 to produce a thumbnail image. In response to this instruction, the thumbnail producing unit 56 decompresses the image information received from the disk drive 44, and performs pixel density conversion on the image information corresponding to one frame so as to produce image information of the thumbnail image. The thumbnail image information produced in this manner is associated with the relevant bookmark position by the controller 54, and stored in the memory 53 (step S7 in FIG. 14).

If the controller 54 recognizes that playback of the image file has been completed in step S4 (if YES is obtained in step S4), it determines whether any bookmark position has been stored (step S8 in FIG. 14), as in the embodiment of FIG. 8.

If the controller 54 recognizes from this determination that one or more bookmark position(s) was/were stored, it instructs the disk drive 44 to rewrite the content(s) of the playback pointer(s) to include the bookmark position(s) (step S9 in FIG. 14), and also to rewrite the image information of the thumbnail images (step S10 in FIG. 14). The disk drive 44 rewrites the playback pointers in the same manner as in the embodiment of FIG. 8, acquires the image information of the thumbnail images corresponding to the rewritten playback pointers, and writes the acquired image information of the thumbnail images in the thumbnail region.

The thumbnail images corresponding to the playback pointers are thus produced and recorded in the magnetic disk 45 when the playback pointers are updated. The thumbnail images are thereafter read out from the magnetic disk 45 and displayed when the playback positions are acquired.

In the present embodiment, the frequency of producing the thumbnail images is reduced in comparison with the embodiment of FIG. 8, with the result that processing efficiency is improved. Also, the period of time required from the request of the thumbnail display until the actual display of the thumbnail images is reduced, since the thumbnail images are produced in advance.

Regarding the initial values of the playback pointers in the illustrated embodiments, the leading position of the image information may be set in the playback pointer 1, and values indicating initial (non-designated) bookmark positions may be set in the other playback pointers.

Also regarding the order of priority for rewriting of the playback pointers in the illustrated embodiments, any suitable priority system may be used. A playback pointer in which no bookmark position has been designated may be given top priority, for example. In this case, if bookmark positions are designated in all of the playback pointers, the order of priority may be determined according to increasing playback pointers number, for example.

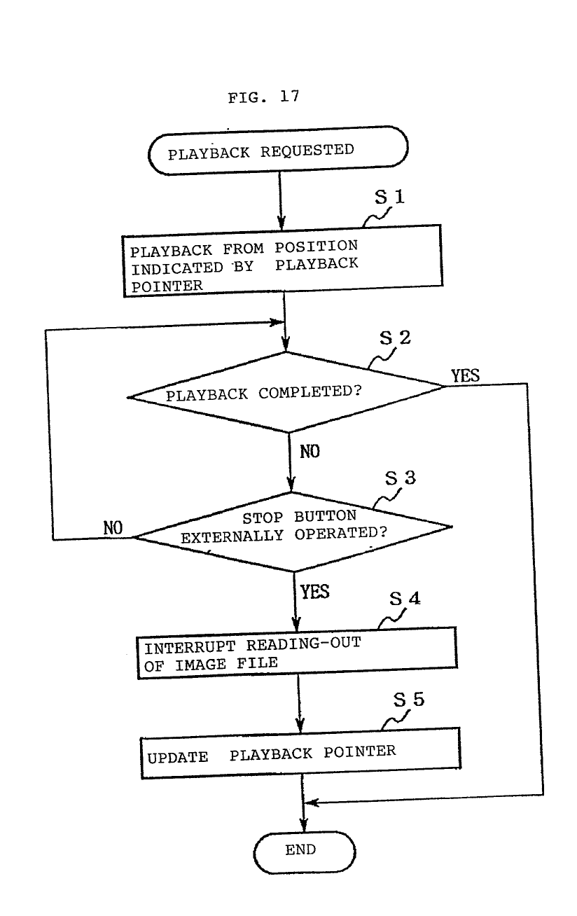

FIG. 16 is a block diagram of an embodiment of the invention implementing the principles shown in FIGS. 1 and 3. In this figure, the same reference numerals are assigned to elements having the same functions as those in the block diagram of FIG. 8, and no further explanation of these elements will be provided.

The arrangement of the present embodiment is different from the arrangement of FIG. 8 in that a controller 58 is provided in place of the controller 40, and the thumbnail processor 46 and memory 53 shown in FIG. 8 are eliminated.

With regard to the relationship between the block diagrams shown in FIGS. 1 and 3 and the present embodiment, the image playback means 10 corresponds to the disk drive 44, display processor 48 and monitor 50; position acquiring means 12 corresponds to the disk drive 44; position storage means 18 corresponds to the disk drive 44; and the recording medium A corresponds to the magnetic disk 45.

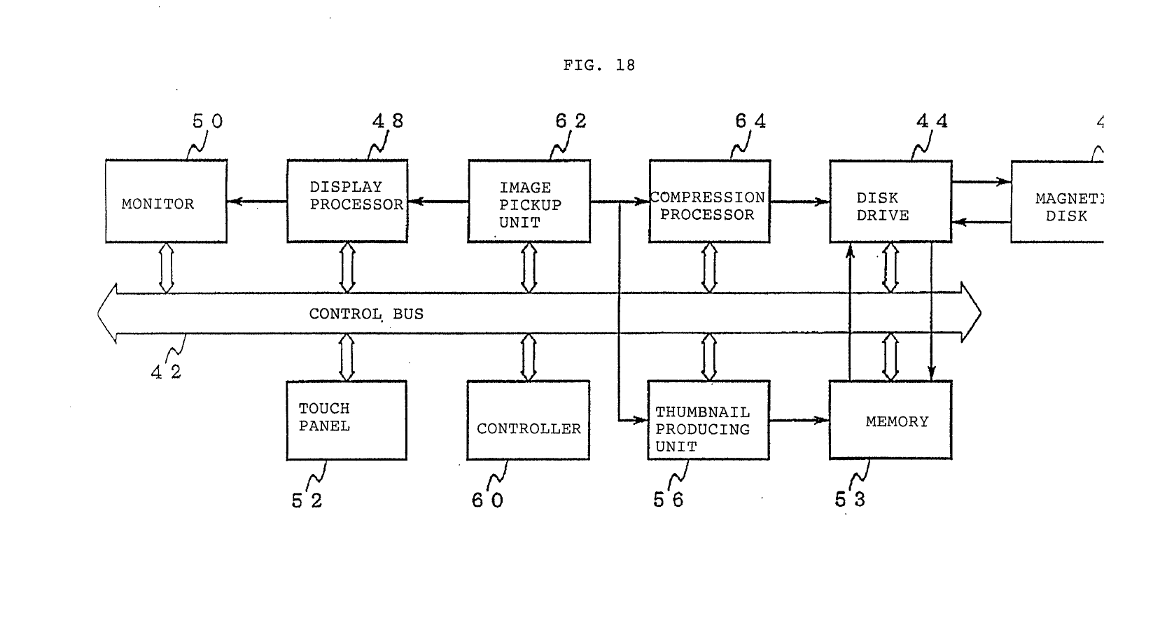

FIG. 17 is a flow chart of the operation of the present embodiment.

In the present embodiment, it is assumed that a single playback pointer (the case of n=1) is provided in the head region of the image file shown in FIG. 12, and the initial read-out starting position is determined in advance.

When the controller 58 recognizes that playback of an image file has been requested, it instructs the disk drive 44 to read out the playback pointer, as in the embodiment of FIG. 8. The controller 58 supplies the value of the playback pointer thus read out to the disk drive 44, and instructs the disk drive 44, display processor 48 and monitor 50 to read out and play back the image information (step S1 in FIG. 17).

In response to this instruction, the disk drive 44 reads out the image information beginning from the position indicated by the playback pointer while updating the read-out counter, in the same manner as in the embodiment of FIG. 8. The image information thus read out is decompressed by the display processor 48, stored in the frame memory, and processed to overlay image information corresponding to the PLAY button, etc., as in the embodiment of FIG. 8. The resulting image information is played back on the monitor 50.

The controller 58 monitors for completion of the playback operation, indicated by an EOF (end of file) marker (step S2 in FIG. 17). If the playback operation is not completed (if NO is obtained in step S2), the controller 58 determines whether or not the STOP button has been externally operated via the touch panel 52 to stop the reading-out operation (step S3 in FIG. 17).

If the controller 58 determines that the reading-out operation is to be stopped (if YES is obtained in step S3), the controller instructs the disk drive 44 to interrupt reading-out of the image file (step S4 in FIG. 17), and to update the playback pointer (step S5 in FIG. 17). In response to this instruction, the disk drive 44 interrupts reading-out of the image file, and writes the value of the read-out counter as the playback pointer in the image file.

Because the playback pointer is rewritten in correspondence with the position in the file when the reading-out operation was interrupted, when the operator requests playback of the image file after the playback interruption, the playback is started at the interrupted position as indicated by the playback pointer.

Although no thumbnail image is displayed in the present embodiment, image information corresponding to one frame located at the position indicated by the playback pointer may be displayed as a thumbnail image, as in the embodiments of FIGS. 8 and 13.

In each of the illustrated embodiments, the image file is selected by an external operation performed via the touch panel 52 on the menu screen displayed on the monitor 50. However, the image file may be selected in any manner, provided that the image file to be read out can be surely recognized by the controller 40 (54, 58).

In each of the illustrated embodiments, the index is provided in which the starting addresses of the image files are written, and a desired image file can be accessed by referring to the index. However, the file organization of the recording medium is not limited to such an indexed organization, and it may be of any type, provided direct access to the image files is possible.

Although initialization of the playback pointers is not described above in connection with the illustrated embodiments, a RESET button may be provided for this purpose, and the playback pointers may be initialized in response to a request of the operator. When the playback pointers are initialized under control of the operator in this manner, the operating efficiency is further improved.

Although the image file used in each of the illustrated embodiments has the image information directly written in its image region, such an image file that acquires image information by referring to image information in another image file may be used, so long as image information to be played back can be reliably obtained.

Although the position at which the image file starts being read out coincides with the position at which the playback is started in the illustrated embodiments, the read-out starting position may be ahead of the playback starting position, provided that the playback can be surely started from the position indicated by the playback pointer.

Although the disk drive 44 reads out only the playback pointer(s) from the head region in the illustrated embodiments, all of the accessory information in the head region may be read out at the point in time when playback is requested by the operator, and the controller 40 (54, 58) may acquire the playback pointer(s) from the accessory information read out in this manner.

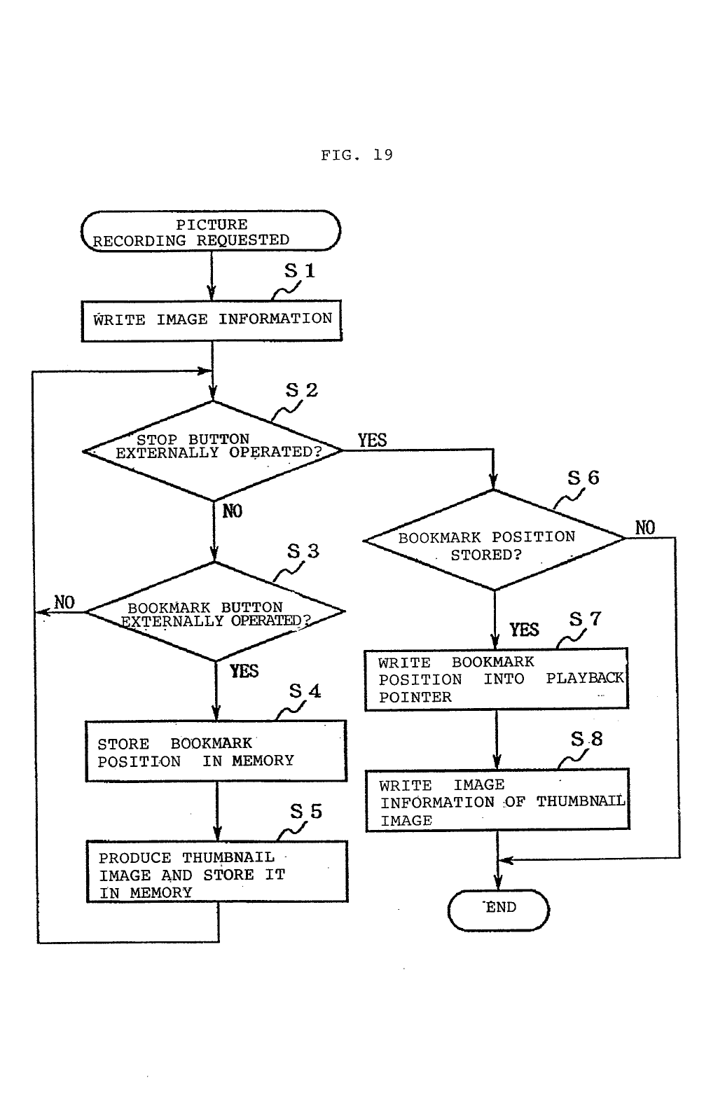

FIG. 18 is a block diagram of an embodiment of the invention implementing the principles shown in FIGS. 6 and 7. In this figure, the same reference numerals are assigned to elements having the same functions as those in the block diagram of FIG. 13, and no further explanation of these elements will be provided.

The arrangement of the present embodiment is different from that of the embodiment of FIG. 13 in that a controller 60 is provided in place of the controller 54 shown in FIG. 13, and an image pickup unit 62 and compression processor 64 are provided which are connected via the control bus 42 to the controller 54.

With regard to the relationship between the block diagrams shown in FIGS. 6 and 7 and the present embodiment, the image writing means 30 corresponds to the image pickup unit 62, compression processor 64 and disk drive 44; the position designating means 32 corresponds to the touch panel 52, display processor 48 and monitor 50; the position recording means 34 corresponds to the disk drive 44 and memory 53; the thumbnail recording means 36 corresponds to the disk drive 44, thumbnail producing unit 56 and memory 53; and the recording medium A corresponds to the magnetic disk 45.

The operation of the present embodiment will now be described.

To inform the operator that picture recording is possible, the controller 60 instructs the image pickup unit 62, display processor 48 and monitor 50 to produce and display an operation screen including a finder. In response to this instruction, the image pickup unit 62 captures an image of the subject, produces its image information, and supplies the image information to the display processor 48.

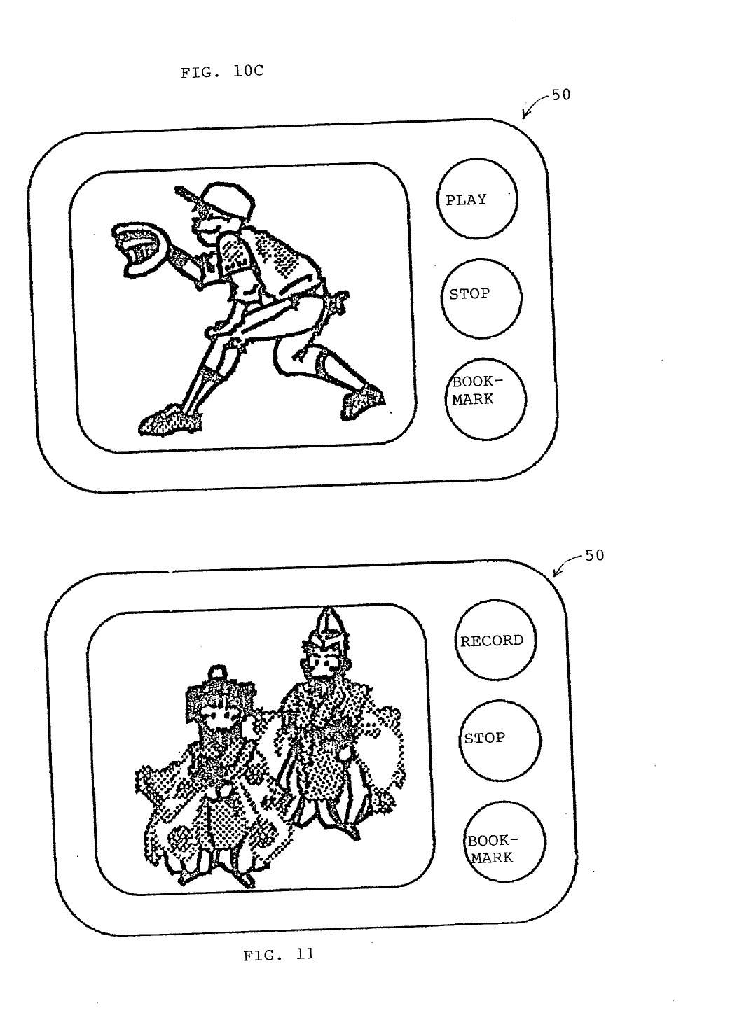

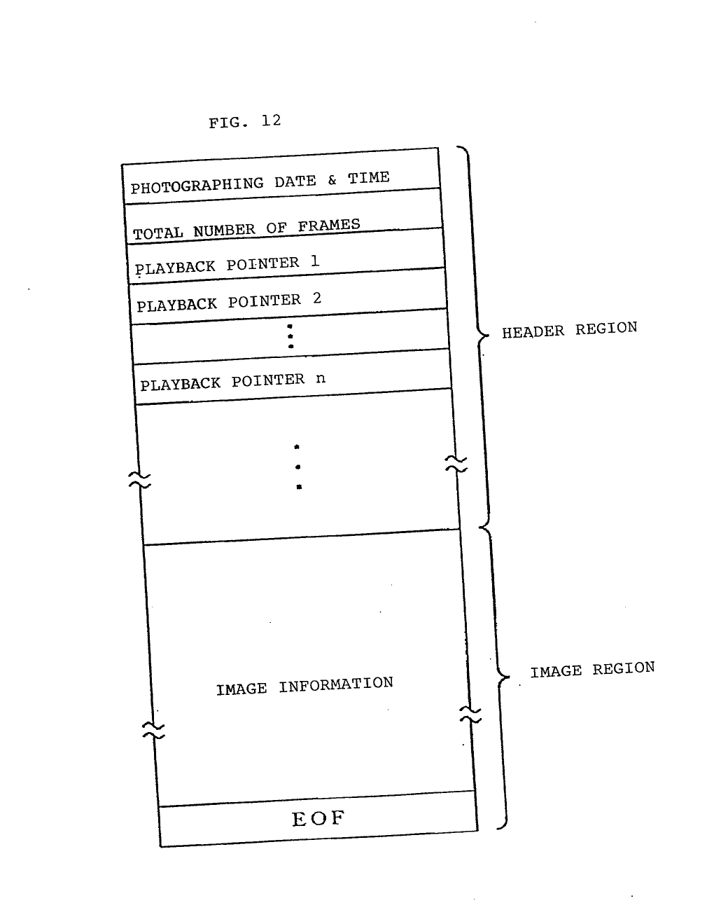

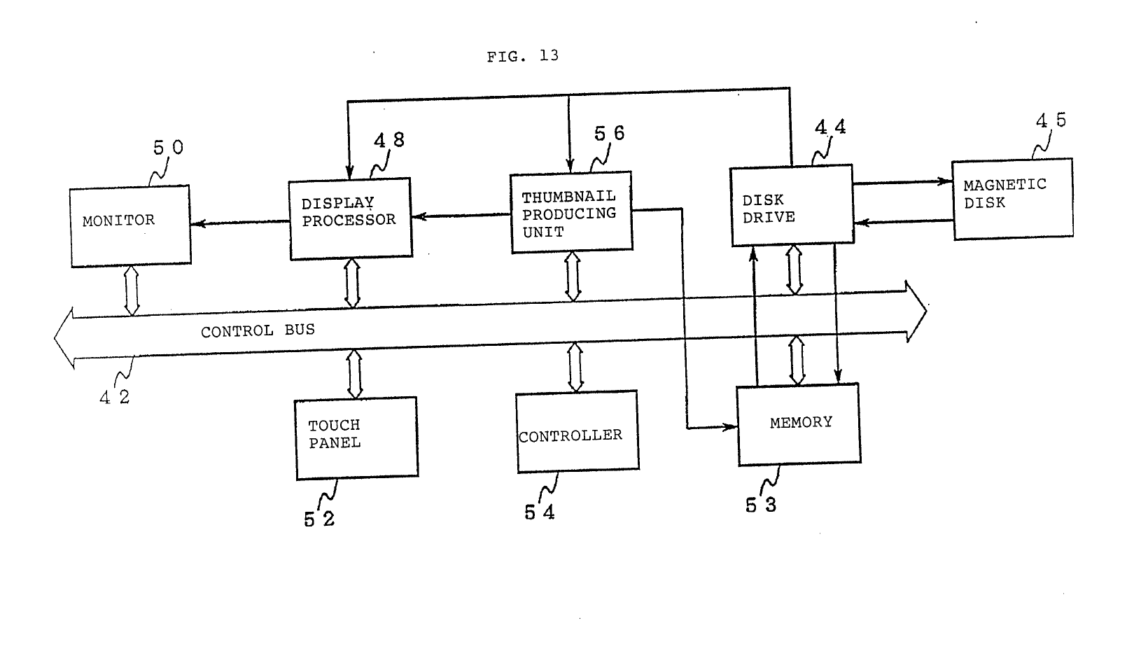

The display processor 48 stores the image information received from the image pickup unit 62, as image information for the finder, in a predetermined position of the frame memory, performs overlay processing on this information and image information corresponding to a RECORD button, a STOP button and a BOOKMARK button, and supplies the resulting information to the monitor 50. The monitor 50, which receives the image information subjected to such overlay processing, provides a display as shown in FIG. 11.

FIG. 19 is a flow chart of the operation from a point when picture recording is requested.

The controller 60 determines whether the RECORD button has been externally operated via the touch panel 52.

When recognizing from this determination that picture recording has been requested, the controller 60 instructs the image pickup unit 62, compression processor 64 and disk drive 44 to produce an image file and write image information (step S1 in FIG. 19). In response to this instruction, the disk drive 44 provides a region of a fixed length corresponding to the header region and thumbnail region shown in FIG. 15 on the recording disk 45, and initializes the playback pointers in the header region. Also, the disk drive 44 provides an image region in accordance with writing of image information.

The image pickup unit 62 supplies produced image information to the compression processor 64. The compression processor 64 processes the received image information, by compression, into the format capable of being written into the magnetic disk 45, and it supplies the compressed information to the disk drive 44. In the present embodiment, the image information produced by the image pickup unit 62 is also supplied to the thumbnail producing unit 56.

The disk drive 44, when supplied with the image information from the compression processor 64, writes the image information into the above-described image region, while controlling the position on the image file by frame. The disk drive 44 is provided with a counter (hereinafter called “writing counter”) that stores, by frame, the position at which the image information is written, and it controls or manages the position in the image file by sequentially updating the writing counter.

While the image information is being written in this manner, the controller 60 determines whether the STOP button was externally operated via the touch panel 52 (step S2 in FIG. 19).

If the writing of the image information is continued (if No is obtained in step S2), the controller 60 determines whether the BOOKMARK button was externally operated via the touch panel 52 (step S3 in FIG. 19), as in the embodiment of FIG. 8.

Each time the controller 60 recognizes from the above determination that the BOOKMARK button was externally operated, it stores the value of the writing counter as a BOOKMARK position in the memory 53 (step S4 in FIG. 19), and instructs the thumbnail producing unit 56 to produce a corresponding thumbnail image (step S5 in FIG. 19). In response to this instruction, the thumbnail producing unit 56 performs pixel density conversion on one frame of the image information supplied by the image pickup unit 62, and produces the image information corresponding to the thumbnail image. The image information of the thumbnail image produced in this manner is associated with the bookmark position by the controller 60 and stored in the memory 53.

If the controller 60 recognizes that the STOP button was externally operated via the touch panel 52 (if YES is obtained in step S2 of FIG. 19), it instructs the disk drive 44 to stop writing of the image information, and to write the playback pointer(s) (step S7 in FIG. 19) and the image information of the thumbnail image(s) (step S8 in FIG. 19) on the disk 45.

When instructed to stop writing, the disk drive 44 writes an EOF (end of file) marker in the position that becomes the terminal end of the image region, and writes accessory information, such as photographing date and time and the total number of frames, which is given according to a predetermined procedure. Also, the disk drive 44 sequentially acquires the bookmark positions from the memory 53, and writes the positions in order from the playback pointer 1 in the header region. Further, the disk drive 44 acquires image information of thumbnail images corresponding to the respective playback pointers written in this manner, and writes this information as image information of thumbnail images in the thumbnail region.

Since the bookmark positions set during picture recording are written as the playback pointers on the recording disk, these positions may be used as candidate positions at which the playback may be started.

Further, since the thumbnail images corresponding to the bookmark positions are also written on the magnetic disk, it is possible to present to the operator candidate playback start positions represented by the thumbnail images.

Although the image pickup unit 62 for producing the image information is provided in the present embodiment, the image information to be written into the magnetic disk 45 may be supplied from outside the apparatus.

Although the bookmark positions can be stored in the memory 53 until reading or writing of the image file is finished as described herein, the controller 40 (54, 60) may notify the disk drive 44 that the BOOKMARK button was externally operated, so that the bookmark positions are held in the disk drive 44.

While the magnetic disk 45 is used as a recording medium in each of the above-described embodiments, the recording medium may be of any type, such as an optical disk, provided the medium is directly accessible.

In each of the illustrated embodiments, the PLAY button, RECORD button, STOP button and BOOKMARK button displayed on the monitor 50 are externally operated via the touch panel 52, so as to request playback, picture-recording, stop, and designate bookmark position, respectively. These buttons, however, may be provided as part of hardware.

Although the monitor is provided as a part of the case in the apparatus of each of the illustrated embodiments, the present invention is not limited to the thus constructed image playback apparatus or image recording apparatus. For example, the image information may be supplied to an external monitor via a terminal for transmitting an image.

Although a particular mode of writing the position in the image file into the playback pointer has not been described in connection with the illustrated embodiments, any mode may be employed, provided that the playback starting position can be reliably indicated by physical address or logical address of the magnetic disk 45, for example.

As will be appreciated from the preceding description, the present invention offers many advantages.

For example, in the invention as shown in FIG. 1, when the same image file is played back again, playback is started from a predetermined position.

In the invention as shown in FIG. 2, the image file may start being played back from any position that has been designated by the operator.

In the invention as shown in FIG. 3, when the image file which was played back part-way is read out again, the playback is started from the position at which the previous playback operation was interrupted, without playing back the same part of the image file again.

In the invention as shown in FIG. 4, since the operator can confirm in advance the image located at the playback position by looking at the corresponding thumbnail image, the operator is able to quickly and reliably select the playback position.

In the invention as shown in FIG. 5, since a thumbnail image is produced at the point in time when the playback position is designated by the position designating means, there is no need to produce a thumbnail image unless the playback position is changed. This results in a reduced number of times when the thumbnail image is produced, and reduced time required for displaying the thumbnail image.

The image playback apparatus to which these aspects of the invention are applied is capable of reliably starting playback from any desired position in the image file.

With the invention as shown in FIG. 6, the position designated during writing of the image file can be used as the position at which the image playback apparatus starts playback of the image file.

With the invention as shown in FIG. 7, the thumbnail images produced during writing of the image file may be used for selection of the playback position by the image playback apparatus.

In the image recording apparatus to which these aspects of the invention are applied, the starting position at which the image playback apparatus start playing back can be designated during writing of the image file.

It is apparent, of course, that although the image playback apparatus and the image recording apparatus of the invention have been described as separate devices, their components may readily be incorporated in a single apparatus to provide a combined image recording/playback device.

It is to be understood, of course, that the various forms of the invention described herein are merely exemplary, and that numerous changes and modifications are possible in keeping with the invention as set forth in appended claims.

The invention claimed is:

1. An image playback apparatus comprising:
image playback means for directly accessing an image file on a recording medium, and reading out and playing back the image file; and
position acquiring means for acquiring positional information indicating a playback position of the image file from a storage location determined based on a file format of the image file,
wherein said image playback means starts playing back the image file from the playback position indicated by the positional information acquired by said position acquiring means.

2. The image playback apparatus as defined in claim 1, further comprising:
position designating means for designating the playback position of the image file in accordance with a designating instruction given from outside during playback of the image file by said image playback means; and
position recording means for storing in said storage location the playback position designated by said position designating means as said positional information.

3. The image playback apparatus as defined in claim 1, further comprising:
position storage means, and
wherein said image playback means interrupts playback of the image file in response to an interrupting instruction given from the outside, and said position storage means stores in said storage location a position of the image file at which playback is interrupted by said image playback means as said positional information.

4. The image playback apparatus as defined in claim 1, further comprising:
thumbnail means for producing a thumbnail image from a playback image at the playback position indicated by said positional information when the positional information is acquired by said position acquiring means, and displaying said thumbnail image; and
position selecting means for specifying the playback position in response to selection of the thumbnail image by an external selecting operation,
wherein said image playback means starts playback of the image file from the playback position specified by said position selecting means.

5. The image playback apparatus as defined in claim 2, further comprising:
thumbnail recording means for producing a thumbnail image from an image at the playback position designated by said position designating means, and storing the thumbnail image in the image file such that the thumbnail image is associated with the playback position;
thumbnail acquiring means for acquiring the thumbnail image from the image file, and displaying the thumbnail image; and
position selecting means for specifying the playback position corresponding to the thumbnail image in response to selection of the thumbnail image by an external selecting operation,
wherein said image playback means starts playback of the image file from the playback position specified by said position selecting means.

6. The image playback apparatus as defined in claim 1, wherein said positional information indicates a playback position of said image file other than a beginning of said image file.

7. An image recording apparatus comprising:
image writing means for writing image information, provided from outside, as an image file in a directly accessible recording medium;
position designating means for designating a position on the image file in accordance with a designating instruction given from outside during writing of the image file by said image writing means; and
position recording means for storing positional information indicating the position designated by said position designating means, at a storage location determined based on a file format of said image file.

8. The image recording apparatus as defined in claim 6, further comprising:
thumbnail recording means for producing a thumbnail image from an image written in said position designated by said position designating means, and storing the thumbnail image in the image file such that the thumbnail image is associated with said position.

9. An image playback apparatus comprising:
an image playback portion which directly accesses an image file on a recording medium, and reads out and plays back the image file; and
a position acquiring portion which acquires positional information indicating a playback position of the image file from a storage location determined based on a file format of the image file,
wherein said image playback portion starts playing back the image file from the playback position indicated by the positional information acquired by said position acquiring portion.

10. The image playback apparatus as defined in claim 9, further comprising:
a position designating portion which designates the playback position of the image file in accordance with a designating instruction given from outside during playback of the image file by said image playback portion; and
a position recording portion which stores in said storage location the playback position designated by said position designating portion as said positional information.

11. The image playback apparatus as defined in claim 9, further comprising:
a position storage portion, and
wherein said image playback portion interrupts playback of the image file in response to an interrupting instruction given from the outside, and said position storage portion stores in said storage location a position of the image file at which playback is interrupted by said image playback portion as said positional information.

12. The image playback apparatus as defined in claim 9, further comprising:
a thumbnail producing portion which produces a thumbnail image from a playback image at the playback position indicated by said positional information acquired by said position acquiring portion, and which displays said thumbnail image; and
a position selecting portion which specifies the playback position in response to selection of the thumbnail image by an external selecting operation,
wherein said image playback portion starts playback of the image file from the playback position specified by said position selecting portion.

13. The image playback apparatus as defined in claim 10, further comprising:
a thumbnail recording portion which produces a thumbnail image from an image at the playback position designated by said position designating portion, and which stores the thumbnail image in the image file such that the thumbnail image is associated with the playback position;
a thumbnail acquiring portion which acquires the thumbnail image from the image file, and which displays the thumbnail image; and
a position selecting portion which specifies the playback position corresponding to the thumbnail image in response to selection of the thumbnail image by an external selecting operation,
wherein said image playback portion starts playback of the image file from the playback position specified by said position selecting portion.

14. The image playback apparatus as defined in claim 9, wherein said positional information indicates a playback position of said image file other than a beginning of said image file.

15. An image recording apparatus comprising:
an image writing portion which writes image information, provided from outside, as an image file in a directly accessible recording medium;
a position designating portion which designates a position on the image file in accordance with a designating instruction given from outside during writing of the image file by said image writing portion; and
a position recording portion which stores positional information indicating the position designated by said position designating portion, at a storage location determined based on a file format of said image file.

16. The image recording apparatus as defined in claim 15, further comprising:
a thumbnail recording portion which produces a thumbnail image from an image written in said position designated by said position designating portion, and which stores the thumbnail image in the image file such that the thumbnail image is associated with said position.

17. An image playback method comprising:
providing a directly accessible storage medium having stored thereon an image file and positional information indicating a playback-starting position of said image file other than a beginning of said image file;
acquiring said positional information; and
starting playback of said image file from the playback-starting position indicated by said positional information.

18. The image playback method as defined in claim 17, further comprising:
rewriting said positional information to change the playback-starting position in accordance with an instruction by an operator.

19. The image playback method as defined in claim 18, wherein said instruction is a stop instruction to interrupt playback of said image file, and the rewritten positional information is dependent upon the interrupted position of said image file.

20. The image playback method as defined in claim 19, wherein the rewritten positional information indicates the interrupted position.

21. The image playback method as defined in claim 18, wherein said instruction is a designating instruction to designate a playback-starting position desired by the operator.

22. The image playback method as defined in claim 21, wherein said designating instruction is provided during a playback of said image file.

23. The image playback method as defined in claim 18, further comprising:
producing a thumbnail image corresponding to the rewritten positional information.

24. An image recording method comprising:
writing image information as an image file on a directly accessible recording medium; and
recording a playback-starting position of the image file on said recording medium in accordance with a designating instruction given at an operator's discretion.

25. The image recording method as defined in claim 24, wherein said designating instruction is given during writing of the image file.

26. The image recording method as defined in claim 24, further comprising:
recording a thumbnail image on said recording medium in correspondence with the designated playback-starting position.
